(19) United States
(12) Patent Application Publication
(10) Pub. No.: US 2009/0273793 A1
(43) Pub. Date: Nov. 5, 2009

(54) Drawing Position Measuring Method and Apparatus, and Drawing Method and Apparatus

(76) Inventors: Takeshi Fukuda, Kanagawa-ken (JP); Norihisa Takada, Kanagawa-ken (JP); Manabu Mizumoto, Kanagawa-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/225,765

(22) PCT Filed: Mar. 28, 2007
(86) PCT No.: PCT/JP2007/056608

§ 371 Date: Sep. 29, 2008

(30) Foreign Application Priority Data
Mar. 31, 2006 (JP) 2006-096797

(51) Int. Cl. G01B 11/14

(52) U.S. Cl. 356/614

(57) ABSTRACT

At least three slits, at least two of which are not parallel to each other, are provided in the same plane as the drawing plane, and light that has been modulated by the drawing point formation means and has passed through the at least three slits is detected. Further, at least two position information items about the drawing point are obtained based on respective relative movement position information items about the drawing plane corresponding to the points of time of detecting the light that has passed through the at least three slits. Further, the position of the drawing point is measured based on the at least two position information items.

### BACKGROUND OF THE INVENTION

1. Field of the Invention

The present invention relates to a drawing position measuring method and apparatus for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means. Further, the present invention relates to a drawing method and apparatus.

2. Description of the Related Art

In recent years, an exposure apparatus that carries out image-exposure on a member to be exposed to light by using a spatial light modulation device, such as a digital micromirror device (DMD), has been developed. In such an exposure apparatus, exposure is carried out using light that has been modulated based on image data.

The DMD is a mirror device in which a multiplicity of micromirrors are two-dimensionally arranged on a semiconductor substrate, such as silicon. The angles of the reflection surfaces of the multiplicity of micromirrors change based on control signals, for example. The angles of the reflection surfaces of the micromirrors are changed by static electric force generated by charges stored in respective memory cells.

In the exposure apparatus using the DMD, as described above, exposure heads that output beams from a plurality of beam output holes are used, for example. In the exposure heads, a lens system collimates laser beams output from a light source for outputting the laser beams, and each of a plurality of micromirrors of the DMD that are arranged substantially at the focal position of the lens system reflects the laser beams. Further, the diameter of the spot of each of the beams output from the beam output holes of the exposure heads is reduced and the beams are imaged on the exposure surface of a photosensitive material (a member to be exposed to light). The diameter of the spot is reduced by a lens system having an optical device, such as a microlens array, that condenses each of the beams by a lens for each pixel. Accordingly, high-resolution image-exposure is carried out.

Further, in the exposure apparatus, a control apparatus controls ON/OFF of each of the micromirrors of the DMD based on control signals that have been generated based on image data or the like to modulate laser beams. The modulated laser beams are output to the exposure surface to carry out exposure.

In the exposure apparatus, a photosensitive material (photoresist or the like) is placed on the exposure surface, and laser beams are output from each of the plurality of exposure heads of the exposure apparatus onto the photosensitive material. Each DMD is modulated based on image data while the positions of the imaged beam spots are relatively moved with respect to the photosensitive material. Accordingly, a pattern-exposure is carried out on the photosensitive material.

Here, for example, when the aforementioned exposure apparatus is used to form a highly accurate circuit pattern on a substrate by exposure, a circuit pattern that is exactly the same as a designed circuit pattern is not always formed because of shifting in positions. Such shifting in positions occurs because lenses that are used in illumination optical systems and imaging optical systems of the exposure heads have intrinsic distortion characteristics, which are called as “distortion”. Therefore, the reflection plane formed by all of the micromirrors of the DMD and the projection image on the exposure surface are not strictly similar to each other, and the projection image on the exposure surface is deformed by distortion.

Therefore, a method for correcting such distortion has been proposed. For example, in a correction method disclosed in Japanese Unexamined Patent Publication No. 2005-316409, a rotated-V-shaped slit and a photo sensor for detecting light that has passed through the slit are provided at an edge portion of an exposure surface. Laser beams that have been output from respective micromirrors of the DMD and have passed through the rotated-V-shaped slit are detected and the position of the exposure surface at the point of time of detection is measured. Accordingly, the position of the beam spot of each of the micromirrors of the DMD is measured. Further, a relative position-shift in the positions is calculated based on information about the position of the beam spot and information about the position of the reflection surface of each of the micromirrors of the DMD. The distortion is corrected by correcting image data based on the calculated position shift.

However, in the method disclosed in Japanese Unexamined Patent Publication 2005-316409, a single rotated-V-shaped slit, which includes two straight-line-shaped slits, is used to measure the positions of beam spots. Therefore, for example, when there is an error in the position at which this slit is formed, the error directly causes an error in the positions of beam spots and accurate positions of the beam spots are not measured. The distortion is not corrected in an appropriate manner, and it is impossible to carry out highly accurate drawing.

Further, when the position of a beam spot is measured using the aforementioned slit, the point of time at which a half value of the maximum light amount of a beam spot is detected by a photo sensor is determined as the point of time of detection of the beam spot, for example. However, for example, when the beam spot is deformed in an asymmetric shape, if the point of time at which a half value of the maximum light amount of a beam spot is detected by a photo sensor is determined as the point of time of detection of the beam spot, it is impossible to accurately measure the position of the beam spot in some cases. In such cases, distortion is not appropriately corrected, and it is impossible to carry out highly accurate drawing.

### SUMMARY OF THE INVENTION

In view of the foregoing circumstances, it is an object of the present invention to provide a drawing position measuring method and apparatus that can more accurately measure the position of a beam spot to carry out highly accurate drawing. Further, it is an object of the present invention to provide a drawing method and apparatus.

A drawing position measuring method of the present invention is a drawing position measuring method for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means, wherein at least three slits, at least two of which are not parallel to each other, are provided in the same plane as the drawing plane, and wherein light that has been modulated by the drawing point formation means and has passed through the at least three slits is detected, and wherein the position of the drawing point is measured based on relative movement position information items about the drawing plane, the relative movement position information items corresponding to the points of time of detecting the light that has passed through the at least three slits.

Further, in the drawing position measuring method of the present invention, the at least three slits may be not parallel to each other.

Further, the widths of the slits may be greater than the diameter of the drawing point.

Further, a plurality of sets of the at least three slits may be provided at a plurality of positions at which the drawing points can be measured.

A drawing method of the present invention is a drawing method, wherein drawing points are sequentially formed on a drawing plane by a plurality of beams formed by a head while the head and the drawing plane are relatively moved with respect to each other, and wherein beams that have passed through at least three slits provided in the same plane as the drawing plane, at least two of the at least three slits being not parallel to each other, are detected, and wherein the positions of the beams are measured based on respective relative movement position information items about the drawing plane, the relative movement position information items corresponding to the points of time of detecting the beams that have passed through the at least three slits, and wherein data for modulating the beams is generated based on the measured positions of the beams, and wherein the data is supplied to the head to modulate the beams and the drawing points are formed on the drawing plane.

A drawing position measuring apparatus of the present invention is a drawing position measuring apparatus for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means, the apparatus comprising:

at least three slits provided in the same plane as the drawing plane, at least two of the at least three slits being not parallel to each other;

a detection means for detecting light that has been modulated by the drawing point formation means and has passed through the at least three slits; and

a position measuring means for measuring the position of the drawing point based on relative movement position information items about the drawing plane, the relative movement position information items corresponding to the points of time of detecting the light, by the detection means, that has passed through the at least three slits.

Further, in the drawing position measuring apparatus, the at least three slits may be not parallel to each other.

Further, the widths of the slits may be greater than the diameter of the drawing point.

Further, a plurality of sets of the at least three slits may be provided at a plurality of positions at which the drawing points can be measured.

A drawing apparatus of the present invention is a drawing apparatus comprising:

a head for forming a plurality of beams;

a mechanism for relatively moving the head and a drawing plane with respect to each other in such a manner that drawing points are sequentially formed on the drawing plane by the beams;

a sensor unit for measuring the positions of the beams on the drawing plane; and

a data processing unit for generating data for modulating the beams based on the measured positions of the beams, wherein the sensor unit includes:

at least three slits provided in the same plane as the drawing plane, at least two of the at least three slits being not parallel to each other;

a sensor for detecting beams that have passed through the at least three slits; and

a position measuring means for measuring the positions of the beams based on respective relative movement position information items about the drawing plane, the relative movement position information items corresponding to the points of time of detecting, by the sensor, the beams that have passed through the at least three slits.

According to the drawing position measuring method and apparatus of the present invention for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means, at least three slits, at least two of which are not parallel to each other, are provided in the same plane as the drawing plane. Further, light that has been modulated by the drawing point formation means and has passed through the at least three slits is detected, and the position of the drawing point is measured based on relative movement position information items about the drawing plane, the relative movement position information items corresponding to the points of time of detecting the light that has passed through the at least three slits. Therefore, for example, if at least two position information items about a drawing point are obtained and the position of the drawing point is measured based on the at least two position information items about the drawing point, even if there is an error in the position of the drawing point or the position at which the slit is formed, the error is averaged by the number of position information items about the drawing point. Therefore, it is possible to further reduce the error. Hence, it is possible to more accurately measure the position of the drawing point.

Further, in the drawing position measuring method and apparatus of the present invention, when the at least three slits are not parallel to each other, even if the drawing point is asymmetrically deformed for example, it is possible to more accurately measure the position of the drawing point, because light that has passed through the slits that have different angles from each other is detected.

According to the drawing method and apparatus of the present invention, it is possible to more accurately measure the position of a drawing point in a manner similar to the aforementioned drawing position measuring method and apparatus. Hence, accurate drawing is possible.

### BRIEF DESCRIPTION OF THE DRAWINGS

FIG. 1 is a schematic perspective view illustrating a whole exposure apparatus using a first embodiment of a drawing position measuring apparatus of the present invention;

FIG. 2 is a schematic perspective view illustrating a state in which a photosensitive material is exposed to light by each of exposure heads in an exposure head unit;

FIG. 3 is a schematic diagram illustrating the structure of an optical system related to the exposure head;

FIG. 4 is an enlarged perspective view illustrating the structure of a DMD;

FIGS. 5A and 5B are diagrams for explaining the operation of the DMD;

FIG. 6A is a plan view illustrating scan tracks of reflection light images (exposure beams) by each of micromirrors when the DMD is not inclined;

FIG. 6B is a plan view illustrating scan tracks of exposure beams when the DMD is inclined;

FIG. 7 is a diagram illustrating slits for detection with respect to an exposure area projected by a single exposure head;

FIG. 8A is a diagram for explaining a state in which the position of a specific pixel that is in an ON state is detected by using a slit for detection;

FIG. 8B is a diagram illustrating a signal when a photo sensor has detected the specific pixel which is in an ON state;

FIG. 9 is a diagram for explaining a method for detecting a specific pixel which is in an ON state by using a slit for detection;

FIG. 10 is a diagram illustrating another embodiment of the slit for detection;

FIG. 11 is a diagram illustrating another embodiment of the slit for detection;

FIG. 12 is a diagram illustrating a state in which a plurality of specific pixels that are in an ON state are detected by using a plurality of slits for detection;

FIG. 13 is a diagram for explaining a distortion amount (distortion state) in drawing, the distortion amount being detected by a distortion amount detection means; and

FIGS. 14A through 14F are diagrams for explaining correction of distortion in drawing.

### DESCRIPTION OF THE PREFERRED EMBODIMENTS

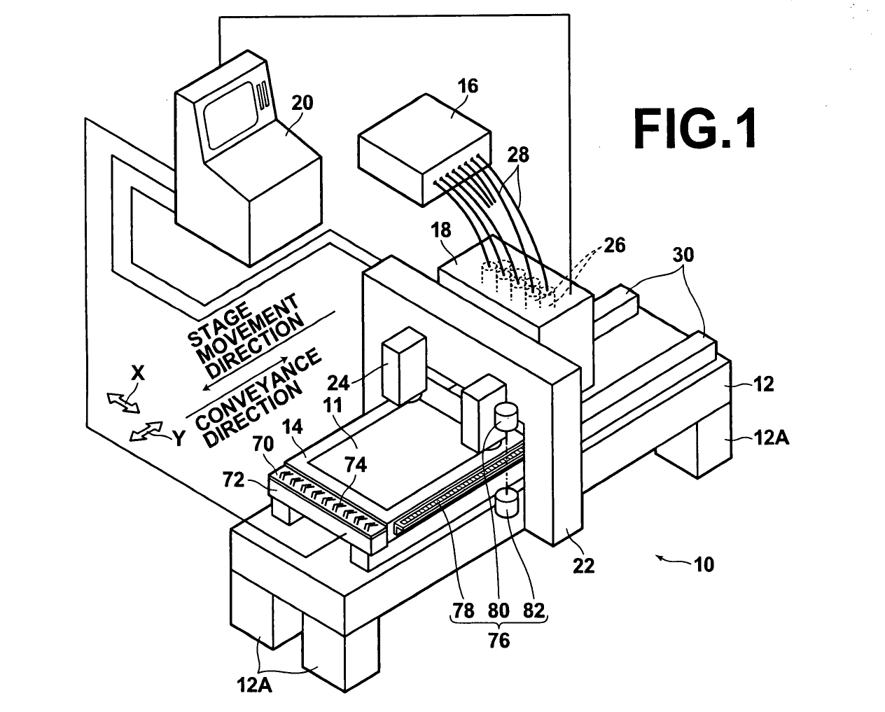

Hereinafter, an exposure apparatus using an embodiment of a drawing position measuring method and apparatus according to the present invention will be described in detail with reference to the attached drawings. FIG. 1 is a schematic perspective view illustrating the structure of an exposure apparatus using an embodiment of the present invention.

As illustrated in FIG. 1, an exposure apparatus 10 has so-called flat-bed-type structure. The exposure apparatus 10 includes a base table 12, a moving stage 14, a light source unit 16, an exposure head unit 18 and a control unit 20. The base table 12 is supported by four leg members 12A. The moving stage 14 is provided on the base table 12 and moves in Y direction in FIG. 1. A photosensitive material is fixed onto the moving stage 14. The light source unit 16 outputs a multi-beam, as laser light, that includes an ultra-violet wavelength region and that extends in one direction. The exposure head unit 18 carries out spatial light modulation, based on intended image data, on the multi-beam according to the position of the multi-beam. Further, the exposure head unit 18 outputs the modulated multi-beam, as an exposure beam, to the photosensitive material that has sensitivity to the wavelength region of the multi-beam. The control unit 20 generates a modulation signal from image data. The modulation signal is supplied to the exposure head unit 18 with the movement of the moving stage 14.

In the exposure apparatus 10, the exposure head unit 18 for exposing the photosensitive material to light is provided over the moving stage 14. Further, a plurality of exposure heads 26 are set in the exposure head unit 18. The exposure heads 26 are connected to bundle-type optical fibers 28, each drawn from the light source unit 16, respectively.

In the exposure apparatus 10, a gate-type frame 22 is provided so as to straddle the base table 12. A pair of position detection sensors 24 is attached to one side of the gate-type frame 22. The position detection sensors 24 send detection signals to the control unit 20 when passage of the moving stage 14 is detected.

In the exposure apparatus 10, two guides 30, which extend along the direction of the movement of the stage, are provided on the upper surface of the base table 12. The moving stage 14 is mounted on the two guides 30 in such a manner that the moving stage 14 can move back and forth. The moving stage 14 is structured in such a manner that it is moved by a linear motor, which is not illustrated, at a relatively low constant speed, such as at 40 mm/second for the movement amount of 1000 mm, for example.

In the exposure apparatus 10, scan exposure is carried out while the photosensitive material (substrate) 11, which is a member to be exposed to light placed on the moving stage 14, is moved with respect to the fixed exposure head unit 18.

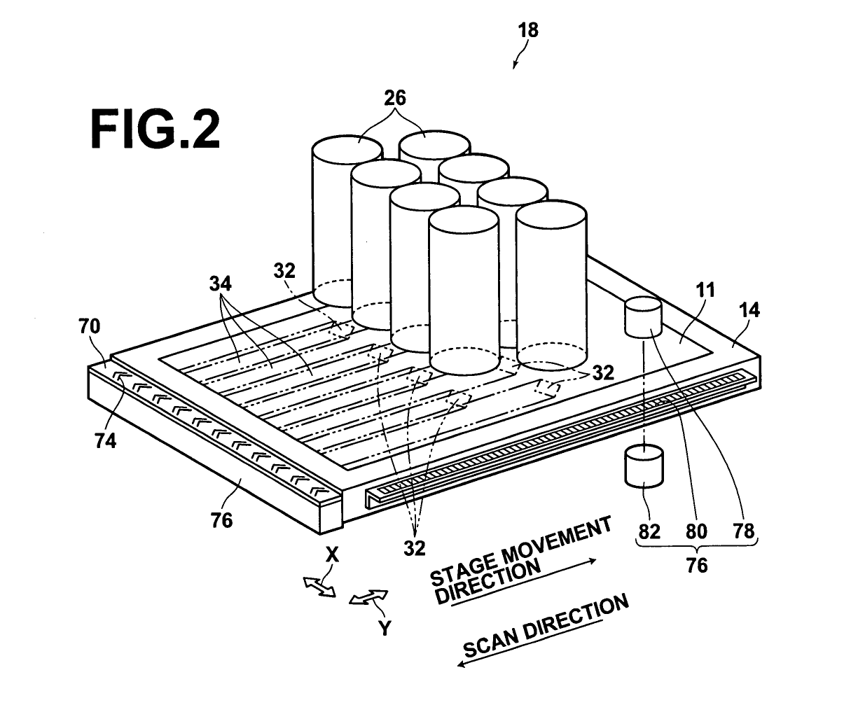

As illustrated in FIG. 2, in the inside of the exposure head unit 18, a plurality of exposure heads 26 (for example, eight exposure heads 26) are arranged substantially in matrix form of m rows×n columns (for example, 2 rows×4 columns).

An exposure area 32 formed by each of the exposure heads 26 has a rectangular shape with its shorter side parallel to the scan direction, for example. In this case, a band-shaped exposed area 34 is formed on the photosensitive material 11 by each of the exposure heads 26 with the movement of the photosensitive material 11 in scan-exposure.

Further, as illustrated in FIG. 2, the exposure heads 26 that are linearly arranged in each row are shifted from those in the other row in the arrangement direction of the exposure heads in the rows by a predetermined distance (a value obtained by multiplying the longer-side length of the exposure area by a natural number). The exposure heads are arranged in such a manner that the band-shaped exposed areas 34 are arranged without any space therebetween in a direction perpendicular to the scan direction. Therefore, for example, an area between an exposure area 32 in the first row and an exposure area 32 in the second row, the area being not exposed to light, is exposed to light by the exposure area 32 in the second row.

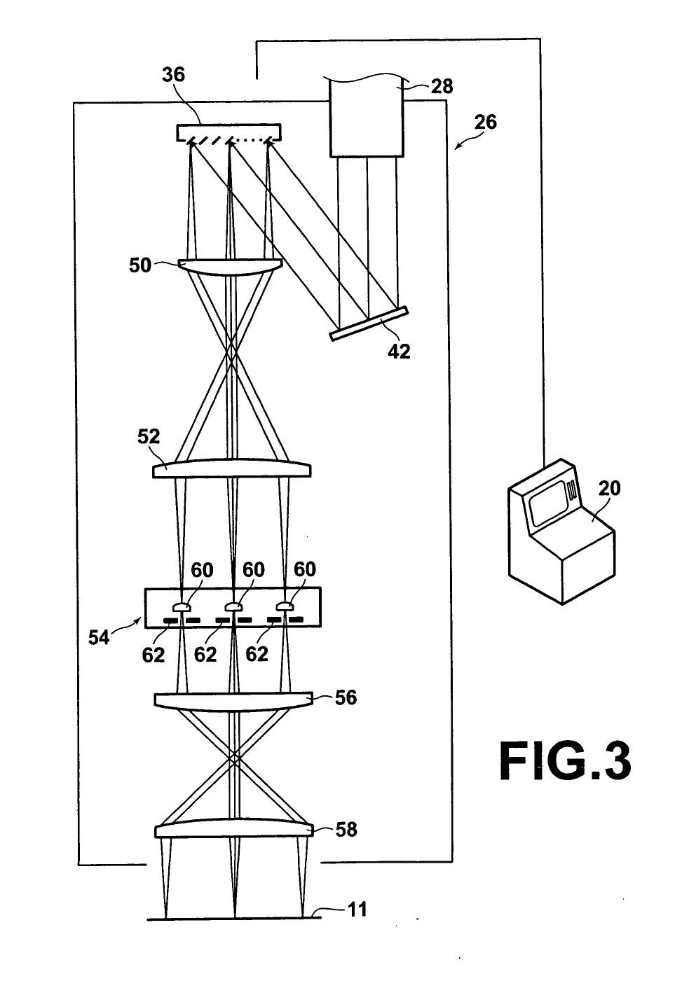

As illustrated in FIG. 3, each of the exposure heads 26 includes a digital micromirror device (DMD) 36 as a spatial light modulation device for modulating incident optical beams based on image data. The DMD 36 is connected to the control unit (control means) 20, which includes a data processing means and a mirror drive control means.

The data processing unit of the control unit 20 generates, based on input image data, a control signal for driving and controlling each of the micromirrors in a region of the DMD 36, the region to be controlled, for each of the exposure heads 26. Further, the mirror drive control means, as a DMD controller, controls the angle of the reflection surface of each of the micromirrors in the DMD 36 for each of the exposure heads 26. The mirror drive control means controls the angle based on the control signal generated by the image data processing unit. The operation for controlling the angle of the reflection surface will be described later.

As illustrated in FIG. 1, the light-entering-DMD-36-side of each of the exposure heads 26 is connected to a bundle-type optical fiber 28 that has been drawn from the light source unit 16, as an illumination apparatus. The light source unit 16 outputs, as laser light, multi-beams that extend in one direction including the ultraviolet wavelength region.

In the light source unit 16, a plurality of wave-combination modules (not illustrated) for combining laser light output from a plurality of semiconductor laser chips and for making the combined light enter the optical fiber are provided. The optical fiber that extends from each of the wave-combination modules is a combined-light fiber for transmitting combined laser light. A plurality of optical fibers are bundled into one to form the bundle-form optical fiber 28.

As illustrated in FIG. 3, in each of the exposure heads 26, a mirror 42 for reflecting the laser light that has been output from the connection end of the bundle-form optical fiber 28 toward the DMD 36 is provided on the light entering side of the DMD 36.

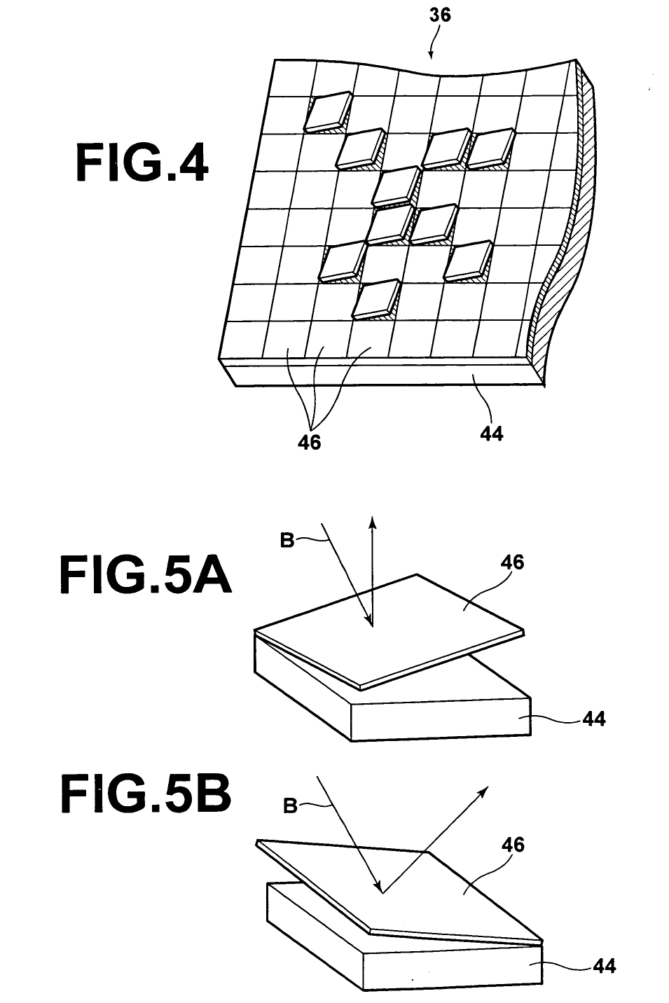

As illustrated in FIG. 4, in the DMD 36, very small mirrors (micromirrors) 46 are arranged on a SRAM cell (memory cell) 44. The micromirrors 46 are supported by posts. The DMD 36 is structured as a mirror device in which a multiplicity of micromirrors (for example, 600×800 micromirrors), each constituting a pixel, are arranged in grid form. In each pixel, a micromirror 46 is arranged at the top, being supported by a post. Further, the surface of the micromirror 36 is coated with a high reflectance material, such as aluminum, that has been deposited by evaporation.

Further, a silicon-gate CMOS SRAM cell 44, which is manufactured in an ordinary semiconductor memory production line, is arranged under the micromirror 46 through the post. The post includes a hinge and a yoke, which are not illustrated. The SRAM cell 44 as a whole is structured monolithically (in an integrated manner).

When a digital signal is written in the SRAM cell 44 of the DMD 36, the micromirror 46 supported by the post is inclined within the range of ±a degrees (for example, ±10 degrees) with respect to the substrate side on which the DMD 36 is placed. The micromirror 46 is inclined with respect to a diagonal line thereof. FIG. 5A illustrates an ON state of the micromirror 46, in which the micromirror 46 is inclined at +a degrees. FIG. 5B illustrates an OFF state of the micromirror 46, in which the micromirror 46 is inclined at −a degrees. Therefore, light that has entered the DMD 36 is reflected to the inclination direction of each of the micromirrors 46 by controlling the inclination angle of the micromirror 46 in each pixel of the DMD 36 as illustrated in FIG. 4.

In FIG. 4, a part of the DMD 36 is enlarged, and a case in which the micromirrors 46 are controlled to be inclined at +a degrees or −a degrees is illustrated. ON/OFF (on/off) control of each of the micromirrors 46 is performed by the control unit 20, connected to the DMD 36. Light that has been reflected by a micromirror 46 that is in an ON state is modulated to an exposure state. Then, the modulated light enters a projection optical system (please refer to FIG. 3) that is provided on the light output side of the DMD 36. Meanwhile, light that has been reflected by a micromirror 46 that is in an OFF state is modulated to a non-exposure state. Then, the modulated light enters a light absorption member (not illustrated).

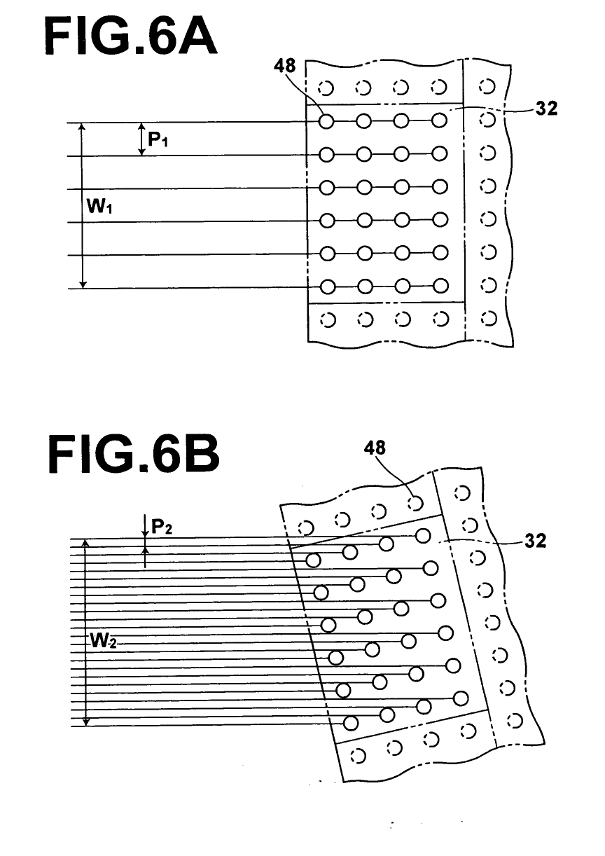

Further, it is desirable that the DMD 36 is slightly inclined in such a manner that the short side direction of the DMD 36 and the scan direction forms a predetermined angle (for example, 0.1° through 0.5°). FIG. 6A illustrates the scan track of a reflection light image (exposure beam) 48 by each micromirror when the DMD 36 is not inclined. FIG. 6B illustrates the scan track of the exposure beam 48 when the DMD 36 is inclined.

In the DMD 36, a multiplicity of micromirrors 46 (for example, 800 micromirrors) are arranged along the longitudinal direction (row direction) thereof. Further, a multiplicity of sets of micromirrors (for example, 600 sets of micromirrors) are arranged in the short side direction thereof. As illustrated in FIG. 6B, pitch P2 of the scan tracks (scan lines) of the exposure beams 48 by the micromirrors 46 when the DMD 36 is inclined is narrower than pitch P1 of the scan lines when the DMD 36 is not inclined. Therefore, it is possible to greatly improve the resolution by inclining the DMD 36. Meanwhile, since the inclination angle of the DMD 36 is very small, scan width W2 when the DMD 36 is inclined and scan width W1 when the DMD 36 is not inclined are substantially the same.

Further, exposure (multiple exposure) is carried out on substantially the same positions (dots) in the same scan line more than once by micromirrors in different columns. Since multiple exposure is carried out, it is possible to control even a very small value as to the exposure position. Hence, it is possible to achieve highly accurate exposure. Further, it is possible to smoothly connect the plurality of exposure heads that are arranged in the scan direction in such a manner that no differences are present at the connecting portions therebetween by controlling the very small value as to the exposure position.

Instead of inclining the DMD 36, the columns of the micromirrors may be arranged in a hound's-tooth check pattern in such a manner that each of the columns of the micromirrors are shifted from each other by a predetermined distance in a direction orthogonal to the scan direction. When the columns of the micromirrors are arranged in such a manner, a similar effect can be obtained.

Next, a projection optical system (imaging optical system) provided on the light reflection side of the DMD 36 in the exposure head 26 will be described. As illustrated in FIG. 3, the projection optical system provided on the light reflection side of the DMD 36 in each of the exposure heads 26 includes optical members for exposure, namely, lens systems 50 and 52, a microlens array 54, and object lens systems 56 and 58. These optical members are arranged in the mentioned order from the DMD 36 side toward the photosensitive material 11 to project a light source image onto the photosensitive material 11 on the exposure surface, which is provided on the light reflection side of the DMD 36.

Here, the lens systems 50 and 52 are structured as magnification optical systems. The lens systems 50 and 52 magnify (enlarge) the area of the section of a flux of rays reflected by the DMD 36, thereby magnifying an exposure area 32 (illustrated in FIG. 2) on the photosensitive material 11, the exposure area 32 being formed by the flux of rays reflected by the DMD 36, to a required size.

As illustrated in FIG. 3, the microlens array 54 includes a plurality of microlenses 60 that are monolithically formed. The plurality of microlenses 60 correspond, one to one, to micromirrors 46 of the DMD 36, which reflects laser light that has been output from the light source unit 16 thereto through respective optical fibers 28. Each of the microlenses 60 is arranged on the optical axis of each laser beam that has passed through the lens systems 50 and 52.

The microlens array 54 is formed in rectangular flat plate form. Further, apertures 62 are monolithically arranged at portions at which the microlenses 60 are formed. The apertures 62 are structured as aperture diaphragms that are arranged so as to correspond, one to one, to the microlenses 60.

As illustrated in FIG. 3, the object lens systems 56 and 58 are structured as same-size (life-size) magnification optical systems, for example. Further, the photosensitive material 11 is arranged on the back-side focal position of the object lens systems 56 and 58. In FIG. 3, each of the lens systems 50 and 52 and the object lens systems 56 and 58 in the projection optical system is illustrated as a single lens. However, each of them may be a combination of a plurality of lenses (for example, a combination of a convex lens and a concave lens).

In the exposure apparatus 10, which is structured as described above, a distortion-amount-in-drawing detection means for appropriately detecting a distortion amount in drawing is provided. The distortion-amount-in-drawing detection means detects distortion of each of the lens systems 50 and 52 and the object lens systems 56 and 58 in the projection optical system of the exposure head 26 or the like and a distortion amount in drawing that changes with passage of time by factors, such as temperatures and vibration when exposure processing is carried out by the exposure head 26.

As a part of the distortion-amount-in-drawing detection means, a beam position detection means for detecting the irradiation positions of beams is arranged on the upstream-side in the conveyance direction of the moving stage 14 in the exposure apparatus 10, as illustrated in FIGS. 1 through 3.

The beam position detection means includes a slit plate 70 and photo sensors 72. The slit plate 70 is integratedly attached to the upstream edge of the moving stage 14. The slit plate 70 is attached along a direction orthogonal to the conveyance direction (scan direction) of the moving stage 14. The photo sensors 72 are arranged on the back side of the slit plate so as to correspond to respective slits.

In the slit plate 70, slits 74 for detection are formed by perforation to pass laser beams that are output from the exposure heads 26.

Each of the slits 74 for detection includes a first rotated-V-shaped slit 75A and a second rotated-V-shaped slit 75B. Each of the rotated-V-shaped slits 75A and 75B is formed by a first slit portion 74a and a second slit portion 74b, one of the ends of each of which is connected to each other at a right angle. The first slit portion 74a is arranged on the upstream-side in the conveyance direction and has straight-line form having a predetermined length. The second slit portion 74b is arranged on the downstream-side in the conveyance direction and has straight-line form having a predetermined length.

Specifically, the first slit portion 74a and the second slit portion 74b are orthogonal to each other. Further, the first slit portion 74a is arranged at 135 degrees with respect to Y axis (traveling direction) and the second slit portion 74b is arranged at 45 degrees with respect to Y axis. In the present embodiment, the scan direction is the Y axis and a direction (the arrangement direction of the exposure heads 26) orthogonal to the scan direction is X axis.

The first slit portion 74a and the second slit portion 74b should be arranged so as to form a predetermined angle. The first slit portion 74a and the second slit portion 74b may be separately arranged to be apart from each other instead of intersecting each other.

Further, in this exposure apparatus, the first slit portion 74a and the second slit portion 74b in the slit 74 for detection are formed in such a manner that the slit widths of the first slit portion 74a and the second slit portion 74b are sufficiently wider than the beam spot BS diameters of Gauss beams so that the photo sensors 72 can obtain a sufficient light amount. The first slit portion 74a and the second slit portion 74b are formed in such a manner that highly accurate measurement is possible by improving the S/N ratio even if the light amount of the beam spot BS, which is a target of detection by the beam position detection means, is low. In short, the slit widths of the first slit portion 74a and the second slit portion in the slit 74 for detection are formed so that the slit widths of the first slit portion 74a and the second slit portion 74b are greater than or equal to the beam spot BS diameters of Gauss beams.

When the slit width of the slit 74 for detection is sufficiently wider than the beam spot BS diameter so that the photo sensor 72 can obtain a sufficient light amount, as described above, the light amount of the beam that irradiates the beam spot BS is fully utilized. Therefore, the amount of light received by the photo sensor 72 can be increased to the maximum value, thereby achieving an efficient S/N ratio.

Here, as generally defined, the term “Gauss beam” refers to a beam that has intensities having Gauss distribution, which distributes symmetrically with respect to the center, on a cross section perpendicular to the beam.

Further, the beam spot diameter in the Gauss beam refers to the diameter of a peripheral portion thereof at which the intensity drops to 1/e² (approximately 13.5%) of the intensity at the central axis.

The first slit portion 74a and the second slit portion 74b in the slit 74 for detection that form an angle of 45 degrees with respect to the scan direction are illustrated. However, the angle with respect to the scan direction may be set to an arbitrary angle as long as the first slit portion 74a and the second slit portion 74b are inclined with respect to the pixel arrangement of the exposure heads 26 and inclined with respect to the scan direction, in other words, with respect to the stage movement direction (the first slit portion 74a and the second slit portion 74b are not parallel to each other). Alternatively, the first slit portion 74a and the second slit portion 74b may be arranged in separated-inverted-V form.

At a predetermined position directly under each of the slits 74 for detection, a photo sensor 72 (a CCD, a CMOS or a photo detector or the like may be used) for detecting light from the respective exposure heads 26 is arranged.

Further, the beam position detection means provided in the exposure apparatus 10 includes a linear encoder 76 for detecting the position of the moving stage 14, as illustrated in FIG. 1. The linear encoder 76 is provided on one side of the moving stage 14 along the conveyance direction of the moving stage 14.

As the linear encoder 76, a generally-sold linear encoder may be used. The linear encoder 76 includes a scale plate 78, which is integratedly attached to the side of the moving stage 14 along the conveyance direction (scan direction) of the moving stage 14. In the scale plate 78, minute slit-form scales that pass light are formed at equal intervals in a flat portion thereof. Further, the linear encoder 76 includes a light projector 80 and a light receiver 82 that are fixed onto a fixed frame (not illustrated) that is provided on the base table 12. The light projector 80 and the light-receiver 82 are provided so as to sandwich the scale plate 78.

This linear encoder 76 is structured in such a manner that a beam for measurement is output from the light projector 80 and the beam for measurement that has passed through the minute slit-form scales of the scale plate 78 is detected by the light receiver 82, which is arranged on the back side of the scale plate 78. Further, the detection signal is sent to the control unit 20.

In this linear encoder 76, when the moving stage 14 located at the initial position is moved by operation, the beam that is output from the light projector 80 is intermittently blocked by the scale plate 78 that moves together with the moving stage 14 and enters the light receiver 82.

Therefore, the exposure apparatus 10 is structured in such a manner that the movement position of the moving stage 4 is recognized by the control unit 20 by counting, at the control unit 20, the number of times of receiving light by the light receiver 82.

In this exposure apparatus 10, the control unit 20, which is a control means, includes an electrical system that functions as a part of the distortion amount detection means.

The control unit 20 includes a CPU as a control apparatus, which also functions as a part of the distortion amount calculation means, and a memory (which are not illustrated). This control apparatus is configured in such a manner that each of the micromirrors 46 in the DMD 36 can be drive-controlled.

Further, this control apparatus receives an output signal from the light receiver 82 of the linear encoder 76 and an output signal from each of the photo sensors 72. Further, the control apparatus performs distortion correction processing on image data based on information in which the position of the moving stage 14 and the condition of output from the photo sensor 72 are correlated to each other and generates an appropriate control signal. The control apparatus controls the DMD 36 based on the generated control signal and drive-controls the moving stage 14 on which the photosensitive material 11 is placed in the scan direction.

Further, the control apparatus controls various kinds of apparatuses, such as the light source unit 16, which are necessary to carry out exposure processing in the exposure apparatus 10, the various kinds of apparatuses being related to the whole exposure processing operation by the exposure apparatus 10.

Next, a method for detecting beam positions in the distortion-amount-in-drawing detection means provided in this exposure apparatus 10 will be described. The beam positions are detected by using the slits 74 for detection and the linear encoder 76.

First, a method for identifying an actual irradiation position on the exposure surface when specific pixel Z1, which is a target measurement pixel, is turned on in this exposure apparatus 10 will be described. The specific position is identified by using the slits 74 for detection and the linear encoder 76.

First, the moving stage 14 is moved by operation and a predetermined slit 74 for detection in the slit plate 70, the predetermined slit 74 for detection being provided for a predetermined exposure head 26, is positioned under the exposure head unit 18.

Next, a control operation is performed so that only the specific pixel Z1 in a predetermined DMD 36 becomes an ON state (ON condition).

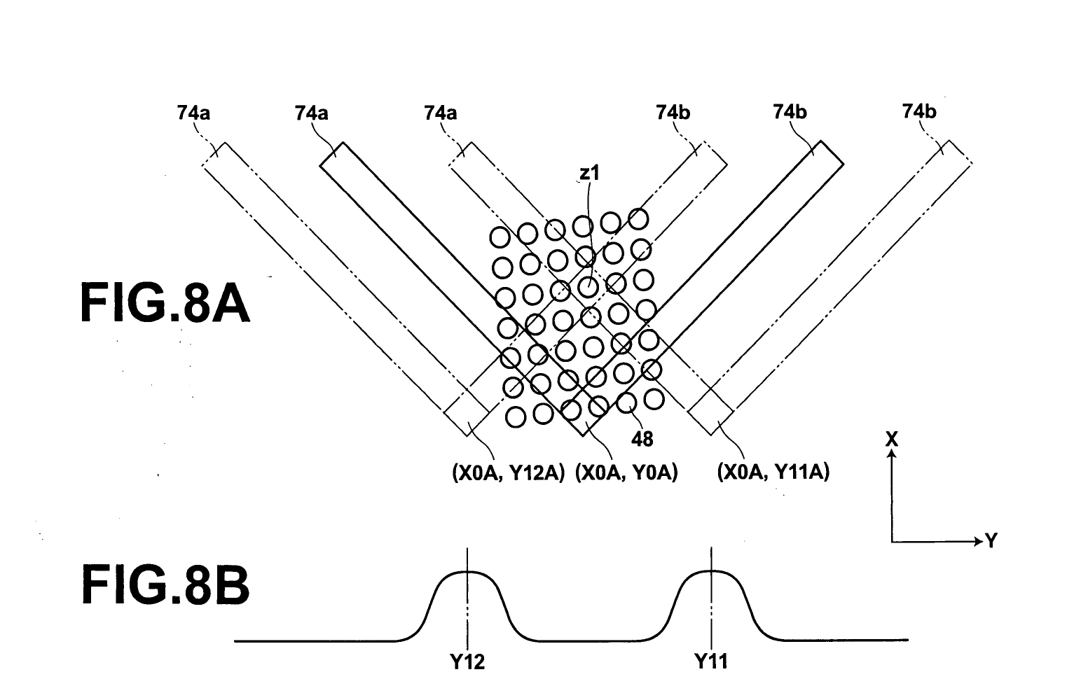

Further, the movement of the moving stage 14 is controlled so that the slit 74 for detection is moved to a required position (for example, a position that should be the origin) on the exposure area 32, as illustrated with solid lines in FIG. 8A. At this time, the control apparatus recognizes an intersection (X0A, Y0A) of the first slit portion 74a and the second slit portion 74b and stores the intersection in the memory. In FIG. 8A, the slit 74 for detection is the first rotated-V-shaped slit 75A.

Next, as illustrated in FIG. 8A, the control apparatus controls the movement of the moving stage 14, and the slit 74 for detection starts moving along the Y axis toward the right side of FIG. 8A.

Then, when the slit 74 for detection passes a position that is illustrated with imaginary lines on the right side of FIG. 8A, the control apparatus performs operation processing on position information about the specific pixel Z1 that is in an ON state, based on the relationship between an output signal when light from the specific pixel Z1 passes through the first slit portion 74a and is detected by the photo sensor 72, as illustrated in FIG. 8B, and the movement position of the moving stage 14. Further, the control apparatus recognizes the intersection of the first slit portion 74a and the second slit portion 74b at this time as point (X0A, Y11A) and stores the recognized point in the memory.

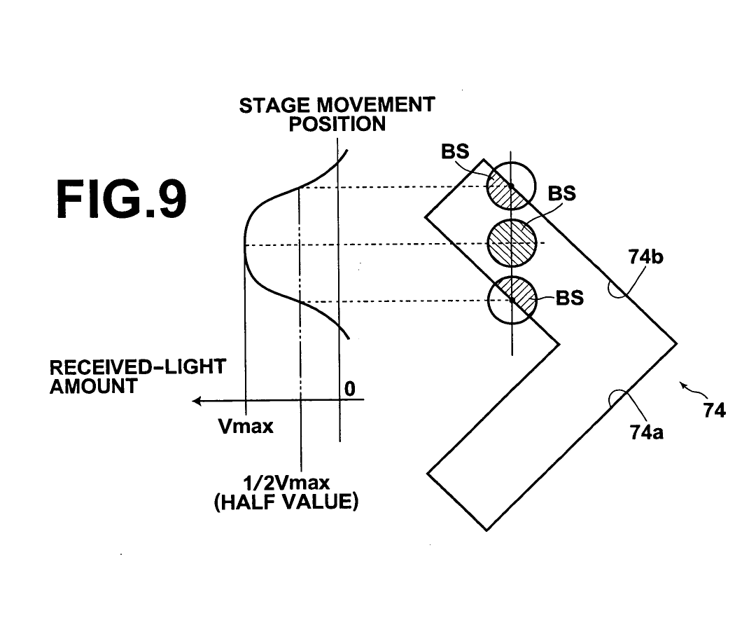

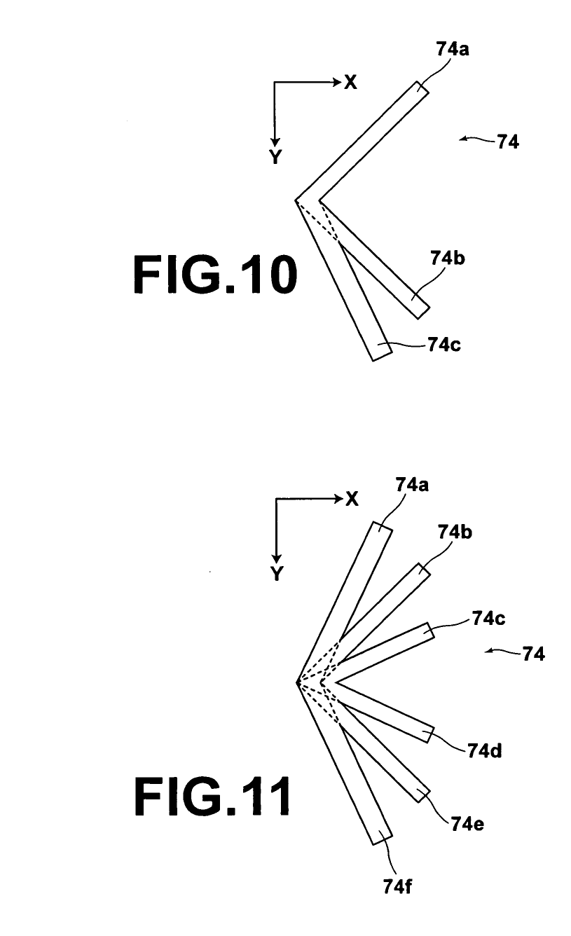

In this beam position detection means, the slit width of the slit 74 for detection is sufficiently wider than the beam spot BS diameter. Therefore, positions at which a detection value by the photo sensor 72 is the highest spread to a certain range, as illustrated in FIG. 9. Therefore, it is impossible to use the positions at which the detection value by the photo sensor 72 becomes the highest as the position of the specific pixel Z1.

Therefore, a half value that is the half of the highest value detected by the photo sensor 72 is calculated. This control apparatus obtains two positions (movement positions of the moving stage 14) when the output from the photo sensor 72 becomes the half value while the moving stage 14 is continuously moved. Each of the two positions is obtained based detection values by the linear encoder 76.

Next, a middle position between a first position when the output from the photo sensor 72 becomes the half value and a second position when the output from the photo sensor 72 becomes the half value is calculated. The calculated middle position is stored in the memory as position information about the specific pixel Z1 (the intersection of the first slit portion 74a and the second slit portion 74b is stored as point (X0A, Y11A)). Accordingly, it is possible to obtain the center position of the beam spot BS as the position of the specific pixel Z1.

Next, an operation for moving the moving stage 14 is performed, and the slit 74 for detection starts moving along the Y axis toward the left side of FIG. 8A. Then, when the slit 74 for detection reaches a position illustrated with imaginary lines on the left side of FIG. 8A, the control apparatus performs operation processing on position information about the specific pixel Z1 that is in an ON state. The control apparatus performs operation processing based on the relationship between an output signal when light from the specific pixel Z1 passes through the first slit portion 74a and is detected by the photo sensor 72, as illustrated in FIG. 8B, and the movement position of the moving stage 14. The operation processing is performed in the same manner as the aforementioned method described with reference to FIG. 9. Further, the control apparatus recognizes the intersection of the first slit portion 74a and the second slit portion 74b at this time as point (X0A, Y12A) and stores the recognized point in the memory.

Next, the control apparatus reads out the coordinates (X0A, Y11A) and (X0A, Y12A), which are stored in the memory, and performs an operation represented by the following equations to obtain the coordinate of the specific pixel Z1. Here, when the coordinate of the specific pixel Z1 is (X1A, Y1A), X1A=X0A+(Y11A−Y12A)/2 and Y1A=(Y11B+Y12B)/2.

Then, the second rotated-V-shaped slit 75B is used and the coordinate X1B, Y1B of the specific pixel Z1 is obtained in a manner similar to the aforementioned method. Since X0A of the first rotated-V-shaped slit 75A and X0B of the second rotate-V-shaped slit are not the same value, the coordinate X1B of the specific pixel, the coordinate having been obtained by using the second rotated-V-shaped slit 75B, is shifted by a shift amount (difference) between X0A and X0B.

Then, an average of the coordinate X1A, Y1A of the specific pixel Z1 that has been obtained by using the first rotated-V-shaped slit 75A and the coordinate X1B, Y1B of the specific pixel Z1 that has been obtained by using the second rotated-V-shaped slit 75B is obtained. Accordingly, the coordinate X1, Y1 of the specific pixel Z1 is obtained.

In the above embodiment, the first rotated-V-shaped slit 75A and the first rotated-V-shaped slit 75B were used and the coordinate X1A, Y1A of the specific pixel Z1 and the coordinate X1B, Y1B of the specific pixel Z1 were obtained, respectively. Further, an average of the two coordinates was calculated to obtain the coordinate X1, Y1 of the specific pixel Z1. However, it is not necessary to obtain the coordinate of the specific pixel Z1 in such a manner. For example, the slit 74 for detection may be composed of three slits, the first slit portion 74a, the second slit portion 74b and a third slit portion 74c. Then, for example, the first slit portion 74a and the second slit portion 74b may be used to obtain the coordinate X1A, Y1B of the specific pixel Z1 in a manner similar to the aforementioned method. Further, the first slit portion 74a and the third slit portion 74c may be used and the coordinate X1B, Y1B of the specific pixel Z1 may be obtained in a manner similar to the aforementioned method. Then, an average of the coordinates may be obtained to get the coordinate X1, Y1 of the specific pixel Z1.

Further, the slit 74 for detection may be composed of six slits, namely, the first slit portion 74a, the second slit portion 74b, the third slit portion 74c, a fourth slit portion 74d, a fifth slit portion 74e and a sixth slit portion 74f, as illustrated in FIG. 11. For example, the first slit portion 74a and the six slit portion 74f may be used in a manner similar to the aforementioned method to obtain the coordinate X1A, Y1B of the specific pixel Z1. Further, the second slit portion 74b and the fifth slit portion 74e may be used in a manner similar to the aforementioned method to obtain the coordinate X1B, Y1B of the specific pixel Z1. Further, the third slit portion 74c and the fourth slit portion 74d may be used in a manner similar to the aforementioned method to obtain the coordinate X1C, Y1C of the specific pixel Z1. Then, an average of the coordinate values XA1, XB1 and XC1 may be obtained to get the coordinate value X1 of the specific pixel Z1. Further, an average of the coordinate values YA1, YB1 and YC1 may be obtained to get the coordinate value Y1 of the specific pixel Z1.

Next, a method for detecting a distortion amount in drawing of an exposure area 32 on an exposure surface will be described. The exposure area 32 is an area onto which an image can be projected by a single exposure head 26.

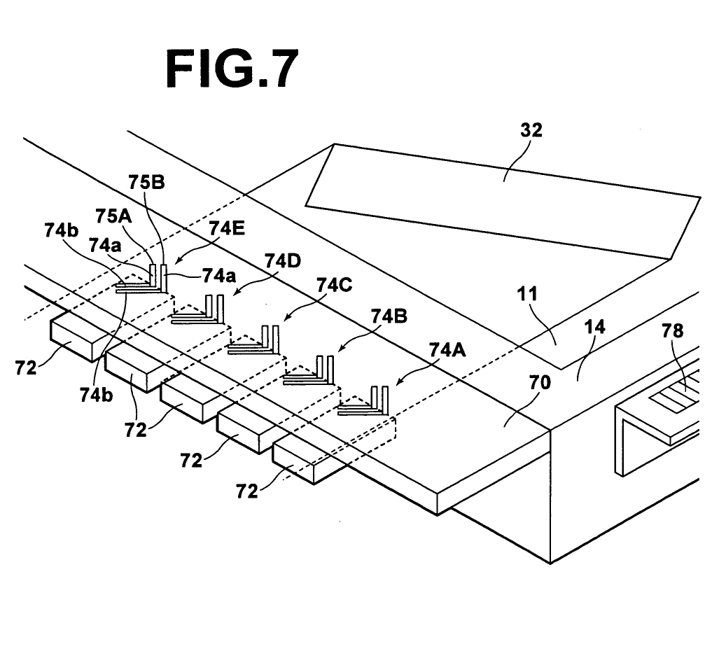

In this exposure apparatus 10, a plurality of slits for detection, five slits 74A through 74E for detection in this embodiment, simultaneously perform position detection with respect to a single exposure area 32, as illustrated in FIG. 7, to detect the distortion amount of the exposure area 32.

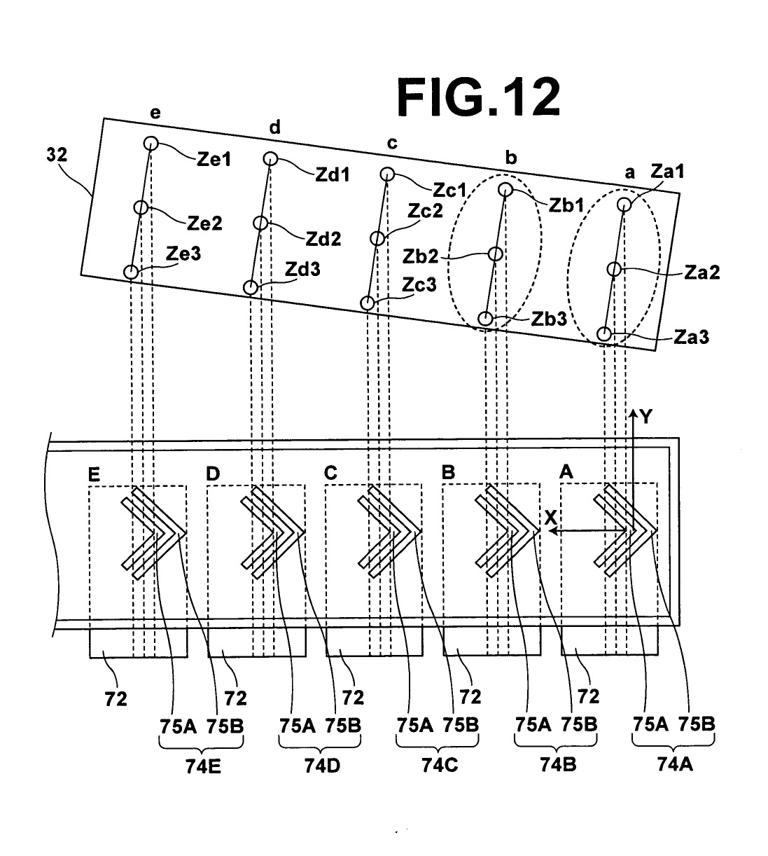

Therefore, a plurality of pixels to be measured that are evenly dispersed and scattered are set within the exposure area 32 that is projected by a single exposure head 26. In this embodiment, five sets of pixels to be measured are set. The plurality of pixels to be measured are set within the exposure area 32 in such a manner that the pixels are located at symmetrical positions with respect to the center of the exposure area 32. In the exposure area 32 illustrated in FIG. 12, a set (here, a set includes three pixels to be measured) of pixels to be measured Zc1, Zc2 and Zc3 is arranged at a middle position with respect to the longitudinal direction. Further, two sets of pixels to be measured are set on either side of the set of pixels at the middle position in such a manner that the two sets of pixels to be measured on one side and the two sets of pixels to be measured on the other side are symmetrically arranged with respect to the middle position. The two sets of pixels to be measured that are set on the right side are a pair of a set of pixels Za1, Za2 and Za3 to be measured and a set of pixels Zb1, Zb2 and Zb3 to be measured. The two sets of pixels to be measured that are set on the left side are a pair of a set of pixels Zd1, Zd2 and Zd3 to be measured and a set of pixels Ze1, Ze2 and Ze3 to be measured.

Further, as illustrated in FIG. 12, five slits 74A, 74B, 74C, 74D and 74E for detection are arranged in the slit plate 70. The slits for detection are located at positions corresponding to the sets of pixels to be measured, respectively, in such a manner that each of the sets of pixels to be measured can be detected.

Next, when the control apparatus detects the amount of distortion of the exposure area 32, the control apparatus controls the DMD 36 and sets a predetermined group of pixels (Za1, Za2, Za3, Zb1, Zb2, Zb3, Zc1, Zc2, Zc3, Zd1, Zd2, Zd3, Ze1, Ze2 and Ze3) to be measured to an ON state. Then, the moving stage 14 onto which the slit plate 70 is set is moved to directly under each of the exposure heads 26. Accordingly, the coordinate of each of these pixels to be measured is obtained by using the slits 74A, 74B, 74C, 74D and 74E for detection corresponding to the respective pixels to be measured. At this time, each of the pixels to be measured in the predetermined group of pixels to be measured may be independently tuned on to set them to an ON state. Alternatively, all of the pixels in the predetermined group of pixel to be measured may be set to an ON state and detection may be performed.

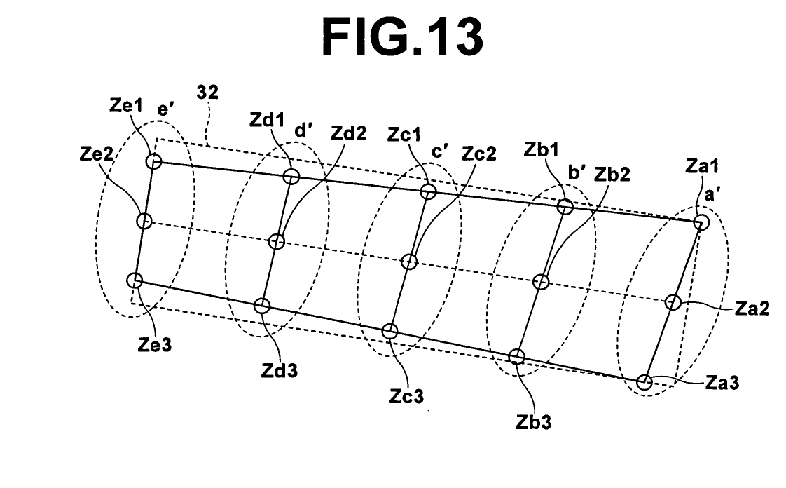

Next, the control apparatus calculates a relative position shift of each of pixels to be measured, based on position information about the reflection surface of predetermined micromirrors 46 in the DMD 36, the micromirrors corresponding to the respective pixels to be measured, and position information about the exposure point of a predetermined light beam projected from the predetermined micromirror 46 onto the exposure surface (exposure area 32), the position information about the exposure point being detected by using the slits 74 for detection and the linear encoder 76. Accordingly, the distortion amount (distortion state) in drawing within the exposure area 32, as illustrated in FIG. 13, is obtained.

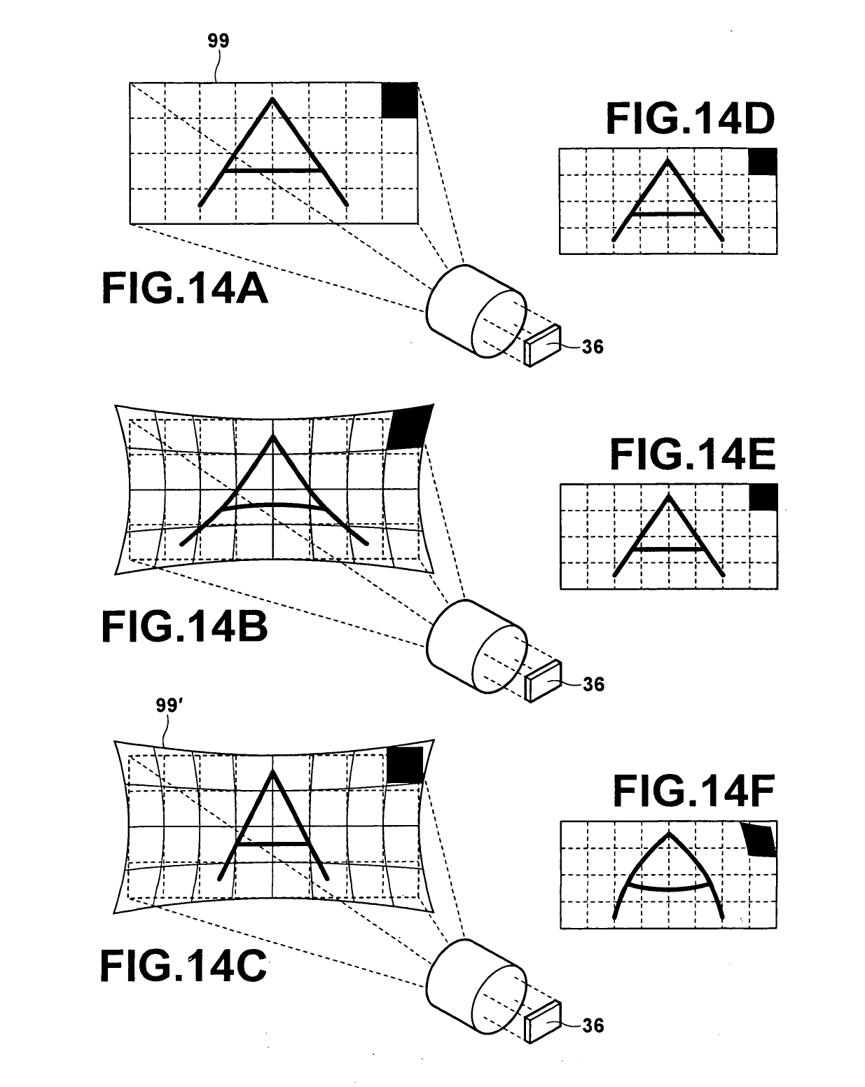

FIG. 14 illustrates a distortion in drawing in a head, a method for correcting the distortion and an influence on an image.

If the optical systems and the photosensitive material have no distortion, an ideal image as illustrated in FIG. 14A is drawn by outputting image data that is input to the DMD 36 onto the photosensitive material 11 even if correction processing is not particularly performed as in the case of FIG. 14B.

However, when exposure processing is carried out using an output beam, if distortion in drawing that changes by factors, such as temperatures and vibration, occurs within an image by a single head, an image 99 formed by exposure in the exposure area 32 is deformed as illustrated in FIG. 14C (if the image is directly input to the DMD 36 without correction). Therefore, correction is required.

Therefore, image data that is input to the DMD 36 is corrected as illustrated in FIG. 14F, and an image itself that is to be output onto the photosensitive material 11 is appropriately corrected based on a distortion amount in drawing obtained by a distortion amount operation means. The distortion amount operation means obtains the distortion amount in drawing based on the position information detected by the position shift detection means. If the image is corrected in such a manner, finally, it is possible to obtain a correct image 99′ that has no distortion.

Next, the operation of the exposure apparatus 10, which is structured as described above, will be described.

Although illustration is omitted, in the light source unit 16, which is a fiber array light source provided in this exposure apparatus 10, laser beams, such as ultraviolet rays, that have been output from each of the laser output devices in divergent light state are collimated by a collimator lens and condensed by a condensing lens. The condensed light is input to the multimode optical fiber from the light incident surface of the core of the multimode optical fiber and the light propagates through the multimode optical fiber. The light that has propagated through the multimode optical fiber is combined into a single laser beam at the laser output portion of the multimode optical fiber. The combined light is output from an optical fiber 28 that is connected to the light output portion of the multimode optical fiber.

In this exposure apparatus 10, image data based on an exposure pattern is input to the control unit 20 that is connected to the DMD 36 and temporarily stored in the memory in the control unit 20. The image data represents the density of each pixel forming an image. The image data is represented by two values (whether or not a dot is recorded). This image data is appropriately corrected by the control apparatus based on the distortion amount (distorted state) in drawing that has been detected by the aforementioned distortion-amount-in-drawing detection means.

The moving stage 14 onto the surface of which the photosensitive material 11 has been sucked is moved at constant speed along the guides 30 from the upstream side to the downstream side in the conveyance direction by a drive apparatus, which is not illustrated. When the moving stage 14 passes under the gate-type frame 22, if the leading edge of the photosensitive material 11 is detected by the position detection sensor 24 attached to the gate-type frame 22, corrected image data is sequentially read out from the memory in such a manner that corrected image data for a plurality of lines is read out at one time. The corrected image data is data obtained by performing correction based on the distortion amount in drawing that has been detected by the distortion-amount-in-drawing detection means and stored in the memory. Then, a control signal is generated for each of the exposure heads 26 based on image data that has been read out by the control apparatus as a data processing unit. When the control signal is generated for each of the exposure heads 26 based on uncorrected image data that has been read out by the control apparatus, processing for correction may be performed based on the distortion amount (distortion state) in drawing, the distortion amount being detected by the aforementioned distortion-amount-in-drawing detection means. Then, ON/OFF control is performed, based on the generated control signal, on each of the micromirrors of the spatial light modulation device (DMD) 36 for each of the exposure heads 26.

When the laser light is output from the light source unit 16 to the spatial light modulation device (DMD) 36, laser light that is reflected by a micromirror of the DMD 36 when the micromirror is in an ON state is imaged at an appropriately-corrected exposure position for drawing. In such a manner, ON/OFF of the laser light output from the light source unit 16 is controlled for each pixel and exposure processing is carried out on the photosensitive material 11.

Further, since the photosensitive material 11 moves at constant speed together with the moving stage 14, the photosensitive material 11 is scanned by the exposure head unit 18 in a direction opposite to the stage movement direction. Accordingly, a band-shaped exposed region 34 (illustrated in FIG. 2) is formed by each of the exposure heads 26.

When the exposure head unit 18 finishes scanning the photosensitive material 11 and the position detection sensor 24 detects the rear edge of the photosensitive material 11, the moving stage 14 is returned to the origin by a drive apparatus, which is not illustrated. The moving stage 14 is returned along the guides 30 to the origin, which is at the most upstream side in the conveyance direction. Then, the moving stage 14 is moved again along the guides 30 at constant speed from the upstream side to the downstream side in the conveyance direction.

Further, in the exposure apparatus 10 according to the present embodiment, the DMD has been used as the spatial light modulation device in the exposure head 26. However, an MEMS (Micro Electro Mechanical Systems) type spatial light modulation device (SLM: Spetial Light Modulator) or a spatial light modulation device other than the MEMS type, such as an optical element (PLZT element) that modulates transmission light by an electro-optical effect and a liquid crystal light shutter (FLC), may be used instead of the DMD.

The MEMS is a general term representing a micro-system, in which a micro-size sensor, a micro-size actuator and a micro-size control circuit have been integrated using micro-machining techniques based on IC manufacturing process. The MEMS type spatial light modulation device refers to a spatial light modulation device that is driven by an electric mechanical operation utilizing electrostatic force.

Further, in the exposure apparatus 10 according to the present embodiment, the spatial light modulation device (DMD) 14 that is used in the exposure head 26 may be replaced by a means for selectively turning ON/OFF a plurality of pixels (a means for selectively modulating a plurality of pixels). The means for selectively turning ON/OFF a plurality of pixels may be structured, for example, by using a laser light source that can output a laser beam corresponding to each of the pixels by selectively turning ON/OFF the laser beam. Alternatively, the means for selectively turning ON/OFF a plurality of pixels may be structured by using a laser light source in which a surface-emitting laser device is formed by arranging micro-laser-emitting-surfaces so as to correspond to respective pixels, and which can output light by selectively turning ON/OF each of the micro-laser-emitting-surfaces.

1. A drawing position measuring method for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means, wherein at least three slits, at least two of which are not parallel to each other, are provided in the same plane as the drawing plane, and wherein light that has been modulated by the drawing point formation means and has passed through the at least three slits is detected, and wherein the position of the drawing point is measured based on relative movement position information items about the drawing plane, the relative movement position information items corresponding to the points of time of detecting the light that has passed through the at least three slits.

2. A drawing position measuring method, as defined in claim 1, wherein the at least three slits are not parallel to each other.

3. A drawing position measuring method, as defined in claim 1, wherein the widths of the slits are greater than the diameter of the drawing point.

4. A drawing position measuring method, as defined in claim 1, wherein a plurality of sets of the at least three slits are provided at a plurality of positions at which the drawing points can be measured.

5. A drawing method, wherein drawing points are sequentially formed on a drawing plane by a plurality of beams formed by a head while the head and the drawing plane are relatively moved with respect to each other, and wherein beams that have passed through at least three slits provided in the same plane as the drawing plane, at least two of the at least three slits being not parallel to each other, are detected, and wherein the positions of the beams are measured based on respective relative movement position information items about the drawing plane, the relative movement position information items corresponding to the points of time of detecting the beams that have passed through the at least three slits, and wherein data for modulating the beams is generated based on the measured positions of the beams, and wherein the data is supplied to the head to modulate the beams and the drawing points are formed on the drawing plane.

6. A drawing position measuring apparatus for measuring the position of a drawing point when an image is drawn by relatively moving a drawing point formation means for forming drawing points on a drawing plane by modulating incident light and the drawing plane with respect to each other and by sequentially forming the drawing points on the drawing plane by the drawing point formation means, the apparatus comprising:
at least three slits provided in the same plane as the drawing plane, at least two of the at least three slits being not parallel to each other;
a detection means for detecting light that has been modulated by the drawing point formation means and has passed through the at least three slits; and
a position measuring means for measuring the position of the drawing point based on relative movement position information items about the drawing plane, the relative movement position information items corresponding to the points of time of detecting the light, by the detection means, that has passed through the at least three slits.

7. A drawing position measuring apparatus, as defined in claim 6, wherein the at least three slits are not parallel to each other.

8. A drawing position measuring apparatus, as defined in claim 6, wherein the widths of the slits are greater than the diameter of the drawing point.

9. A drawing position measuring method, as defined in claim 6, wherein a plurality of sets of the at least three slits are provided at a plurality of positions at which the drawing points can be measured.

10. A drawing apparatus comprising:
a head for forming a plurality of beams;
a mechanism for relatively moving the head and a drawing plane with respect to each other in such a manner that drawing points are sequentially formed on the drawing plane by the beams;
a sensor unit for measuring the positions of the beams on the drawing plane; and
a data processing unit for generating data for modulating the beams based on the measured positions of the beams, wherein the sensor unit includes:
at least three slits provided in the same plane as the drawing plane, at least two of the at least three slits being not parallel to each other;
a sensor for detecting beams that have passed through the at least three slits; and
a position measuring means for measuring the positions of the beams based on respective relative movement position information items about the drawing plane, the relative movement position information items corresponding to the points of time of detecting, by the sensor, the beams that have passed through the at least three slits.

11. A drawing position measuring method, as defined in claim 2, wherein the widths of the slits are greater than the diameter of the drawing point.

12. A drawing position measuring method, as defined in claim 2, wherein a plurality of sets of the at least three slits are provided at a plurality of positions at which the drawing points can be measured.

13. A drawing position measuring method, as defined in claim 3, wherein a plurality of sets of the at least three slits are provided at a plurality of positions at which the drawing points can be measured.

14. A drawing position measuring method, as defined in claim 7, wherein a plurality of sets of the at least three slits are provided at a plurality of positions at which the drawing points can be measured.

15. A drawing position measuring method, as defined in claim 8, wherein a plurality of sets of the at least three slits are provided at a plurality of positions at which the drawing points can be measured.
